(19) United States
(12) Patent Application Publication
(10) Pub. No.: US 2010/0164244 A1
(43) Pub. Date: Jul. 1, 2010

(54) BULB CLEANING AND INSTALLATION POUCH AND METHOD

(75) Inventors: Logan D. Pitts, North Muskegon, MI (US); Christian R. Byar, Spring Lake, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: AGS I-PROP, LLC, Muskegon, MI (US)

(21) Appl. No.: 12/722,102

(22) Filed: Mar. 11, 2010

Related U.S. Application Data
(62) Division of application No. 12/035,516, filed on Feb. 22, 2008.
(60) Provisional application No. 60/892,321, filed on Mar. 1, 2007.

(51) Int. Cl. A45F 5/00; B08B 7/00; B23P 6/00

(52) U.S. Cl. 294/141; 134/6; 29/402.08

(57) ABSTRACT

A method of handling a high heat lighting bulb includes providing a pouch that has a substantially non-porous flexible outer skin portion and an inner lining material. The non-porous flexible outer skin portion is substantially sealed around the inner lining. A high heat lighting bulb having a bulb portion and a power connecting portion is provided and the pouch is opened to expose the inner lining. The inner lining forms a receptacle that is configured for receiving the bulb portion of the high heat lighting bulb therein when the pouch is opened. The bulb portion of the lighting bulb is inserted into the opened pouch and into contact with the inner

### CROSS REFERENCE TO RELATED APPLICATIONS

The present application is a divisional application of U.S. patent application Ser. No. 12/035,516, filed Feb. 22, 2008, which claims the benefit of U.S. provisional application, Serial No. 60/892,321, filed Mar. 1, 2007, which are hereby incorporated herein by reference in their entireties.

### FIELD OF THE INVENTION

The present invention relates generally to the installation and/or cleaning of light bulbs and, more particularly, the installation and/or cleaning of halogen light bulbs or other bulbs that provide enhanced lighting.

### BACKGROUND OF THE INVENTION

Bulbs for lighting are normally installed by inserting a base or prong into a socket. Lighting bulbs consist of a transparent glass-like or quarter portion containing the lighting mechanism and a base portion fitting into an energy socket portion. Certain types of bulbs, such as halogen bulbs or the like as used in vehicle headlights, retail stores (especially jewelry stores), copying machines and the like, give off a much brighter and more intense light than ordinary incandescent or florescent bulbs. These extra bright bulbs also become extremely hot at the transparent bulb portion—and must be kept clean and free of contamination, such as finger oil, grease and the like, which can cause uneven heating and premature bulb failure. Thus, improved installation of the bulb requires removal of such contaminants that may have occurred during factory manufacturing and packaging as well as user contamination during bulb removal from box or bubble card and during manual installation of the bulb into the socket, which is often in a hard-to-reach place.

Bulbs have traditionally been installed by professional mechanics or electricians by wiping the glass-like portion clean and preferably using a cloth or glove to grip the bulb portion during installation into the socket. However, the gloves or cloths themselves may have some contamination, such as grease or oil or the like, from prior use. In the worst case scenario, the unprotected fingers simply grasp the bulb portion—and condemn the bulb to an uneven heating surface with finger oil and probable inferior performance and shorter life. Such contamination at the surface of the bulb may also lead to a hazy residue on the bulb, which may result in a reduced brightness of the bulb.

### BRIEF DESCRIPTION OF THE DRAWINGS

FIG. 1 is a front elevation of a bulb installation/cleaning packet in accordance with the present invention;

FIG. 2 is a rear elevation of the bulb installation/cleaning packet of FIG. 1;

FIG. 3 is an exploded perspective view of the bulb installation/cleaning packet of the present invention along with a light bulb;

FIG. 4 is another front elevation of the bulb installation/cleaning packet of the present invention;

FIG. 5 is a perspective end view of the bulb installation/cleaning packet when opened;

and

FIGS. 6A and 6B are perspective views of the bulb installation/cleaning packet of the present invention as used to install and/or clean a light bulb.

### DESCRIPTION OF THE PREFERRED EMBODIMENTS

Referring now to the drawings and the illustrative embodiments depicted therein, a bulb handling/installation/cleaning packet or pouch 10 is configured to be opened to receive a portion of a light bulb 12, such as a glass or glass-like (such as a suitable polymeric or polycarbonate material or the like) bulb portion 14 of a halogen light bulb or the like, therein for cleaning and protecting the glass bulb portion of the light bulb during installation of the bulb at a female socket 15 and/or power source 17. The pouch 10 includes a non-porous outer surface or portion or skin 16 and an inner cloth-like element 18, which may be adhered or otherwise secured to the skin 16 or may be loosely retained or positioned within the pouch 10. The pouch 10 is initially a sealed pouch, and may be opened (such as via tearing an end or edge region of the pouch to form an opening at an end or side of the pouch) so as to receive the glass bulb portion 14 of a bulb 12 therein to protect and/or clean the glass bulb portion. The pouch may provide a single use pouch for installing and/or cleaning a single halogen light bulb (or other item or bulb that should not come in direct contact with a person's hand or fingers), or may be used for two or more installation/cleaning processes if desired (although it would not be recommended for use in installing/cleaning several bulbs since each use may cause dirt or contaminants or debris to collect within the pouch).

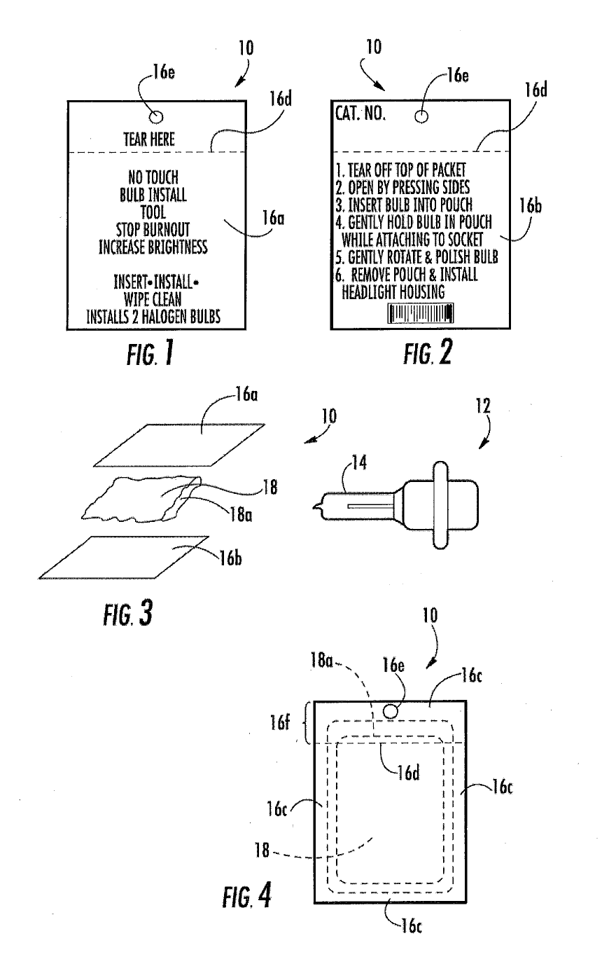

As shown in FIG. 3, the inner cloth-like element 18 may be sandwiched between two opposite outer skin portions 16 (such as between a front skin portion or layer or film or substrate 16a and a rear skin portion or layer or film or substrate 16b). The perimeter edge regions 16c of the skin portions 16 may be sealed or substantially sealed together to seal the inner cloth-like element 18 within the sealed packet or container. The pouch 10 may include a tear line or cut line 16d near an end of the pouch (which may comprise a perforated or partially perforated or weakened or notched region to facilitate tearing open the pouch or which may comprise indicia or markings thereon and there across to indicate to the user where to cut or tear the pouch to open the pouch for use. Optionally, and as shown in FIGS. 1 and 2, the pouch may be provided with a header portion 16f above the cut line 16d and may have an aperture 16e for hanging the pouch 10 at a peg or hanging element at a store (or may include other means for hanging or displaying or supporting the pouch at a store or distribution area). Optionally, the pouch may be provided with a ZIPLOC®-type or peel-open seal or the like that may be opened without tearing or cutting. Although shown and described with two opposite faces or surfaces or layers sealed together around the perimeter regions to seal the inner cloth-like element therein, the outer pouch layer or layers may be otherwise formed, such as unitarily formed or established around the inner cloth-like element, to substantially seal the inner cloth-like element within the pouch, while remaining within the spirit and scope of the present invention.

The inner cloth-like element 18 (which is preferably a lint-free material or fabric or the like) may provide a receiving pocket within the outer skin portion 16 of pouch 10. As can be seen in FIG. 4, the receiving end 18a of the cloth-like element 18 may be disposed generally at or near the cut or tear line 16d of the pouch 10, so as to expose the open receiving end 18a of the cloth-like element 18 when the pouch is opened. As shown in FIG. 4, the inner cloth-like element 18 may extend past the cut line 16d so that the cloth-like element is exposed at the open end of the pouch when the pouch is opened, or optionally the outer skin portion 16 may extend beyond the inner cloth-like element, at least at the end or side which is to be opened, such that the outer skin portion 16 may be torn away at that end or side to open the pouch 10, without tearing the inner cloth-like element 18. Preferably, the inner cloth-like element 18 is formed so as to have its receiving opening at or near the tear or cut line 16d (such as a perforated portion or notched portion or demarcated portion of the outer skin element 16), so that when the skin portion or selectively sealed sheets is/are torn or cut or opened, the opening of the cloth-like element 18 is exposed for receiving the glass bulb portion 14 therein. Optionally, the inner cloth-like element 18 may include or may be saturated with a cleaning solvent or the like, such as alcohol or the like.

The outer skin portion 16 may comprise opposite sheets of non-porous material that are selectively sealed along their perimeter edges to seal or substantially seal the cloth-like element 18 (and cleaning solvent) therein. For example, the outer skin portion may comprise a pair of sheets or sheet portions, such as sheets of printed flat stock or material, such as foil sheets or plastic or polymeric sheets or the like. The sheets may comprise separate sheets sealed or joined or bonded together (such as around their respective peripheral edges or edge regions), or may comprise a single sheet folded over upon itself to form two adjacent sheets or sheet portions, without affecting the scope of the present invention. The sheets may be selectively sealed or bonded or pressed or otherwise joined together to define the pouch or cavity that contains or is lined with the inner cloth-like element. For example, the sheets may be heat sealed together (such as by joining or sealing the sheets together by heating the sheets while they are mated or pressed together) to define the pouch or cavity, whereby the cavity is defined by areas of the sheets that are not sealed or joined or bonded together. Optionally, the pouch may utilize aspects of the pouches described in U.S. Pat. No. 7,241,066, which is hereby incorporated herein by reference in its entirety.

The inner liner may be disposed at or attached to one of the sheets, such as before or as the sheets are sealed together. For example, for a single folded over sheet configuration, the inner liner may be attached to or disposed at the surface of and along the sheet, whereby the pouch is formed when the sheet is folded over on itself with the liner lining the opposed surfaces of the sheet. Likewise, for a dual sheet configuration, the inner liner may be disposed at or attached to a surface of, or the respective surfaces of the sheets, so as to establish a lined pouch when the sheets are mated together and sealed about their peripheries. Optionally, the liner may be pre-formed into a pouch or cavity shape with an opening at one end, and may be disposed at one of the sheets or sheet portions so as to be encased within the sheet or sheet portions when mated together and sealed about their peripheries.

Optionally, the pouch may include graphics and text printed or screened thereon to indicate to the user the purpose of the packet or pouch. For example, one sheet or side of the pouch may include a graphical depiction of a light bulb or the like, while the opposite side or sheet may include directions printed or screened thereon. Optionally, the pouch may utilize aspects of the pouches described in U.S. Pat. No. 7,241,066, incorporated above.

The pouch 10 thus may comprise a sealed pouch so that the inner cloth-like element 18 and solvent are not exposed to the elements or to human contact until the pouch is opened and ready to receive the glass bulb portion 14 therein. Thus, the pouch of the present invention provides a clean, pure, non-contaminated cleaning element and protecting element for use during installation and/or cleaning of the light bulb. After the bulb is installed or cleaned, the used pouch may be discarded and a new pouch may be used for the next procedure.

Because the outer skin portion 16 and inner cloth-like element 18 are flexible materials, the pouch may be readily adapted for receiving and conforming to the glass bulb portion 14. Further, such flexibility and conformability allows the user to readily grasp the pouch 10 with the bulb portion 14 inside the pouch and massage or manipulate the pouch relative to the glass bulb portion to clean the bulb portion before installation (in order to remove any contaminants or residue that may have been established on the glass bulb during packaging or during the process of removing the bulb from its package).

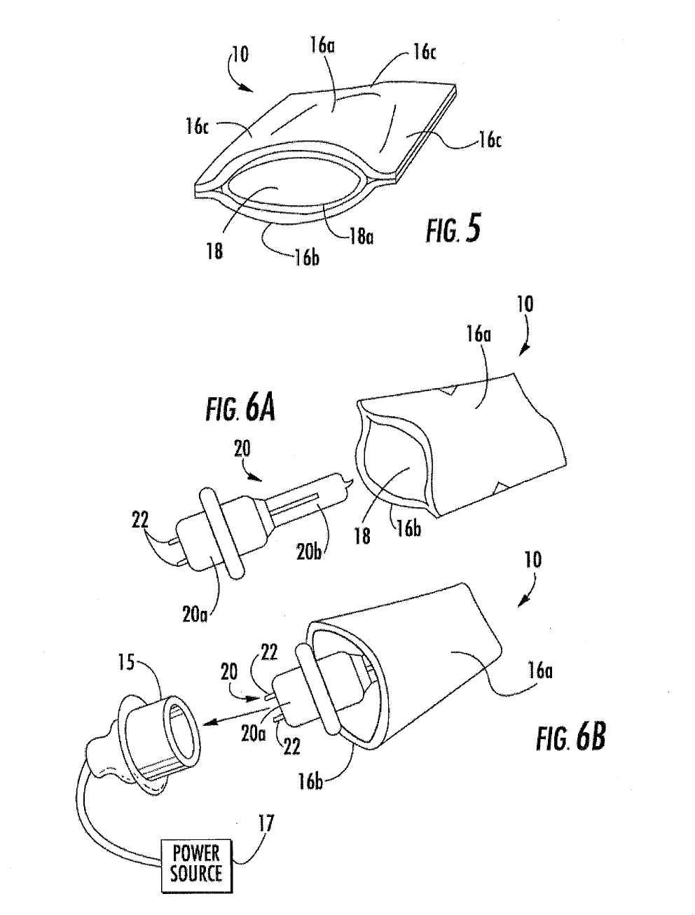

For example, and with reference to FIGS. 6A and 6B, after opening a new pouch, the user may grasp the plug-end or prong-end 20a of a lighting bulb 20 (such as a halogen lighting bulb for a vehicle headlamp or other type of lighting bulb) with one hand and hold the opened pouch 10 in the other hand (and may squeeze the pouch at the side perimeter edge regions to cause the pouch to open or expand at its opened end). The user may insert the glass bulb portion 20b through the opened end of the pouch and into the opened pouch, whereby the hand holding the pouch may gently squeeze the pouch around the glass bulb portion to contact the exterior surface of the glass bulb portion with the inner cloth-like element 18 of the pouch. The user may then move or rotate either or both hands relative to the other to move the cloth-like element over the glass surface of the bulb portion to clean the bulb portion and remove any residue or contaminants that may be at the glass surface.

The user may then release the grip on the prong-end 20a of a lighting bulb 20 so as to hold the bulb via the hand holding the pouch (with the bulb being held via contact with the inner cloth-like element of the pouch only, and without direct human/skin contact to the glass surface of the bulb portion 20b). The user may then move the bulb 20 to the socket to which it is to be installed and insert (and optionally twist or otherwise manipulate the bulb depending on the type of socket connection for that particular bulb) male prongs 22 and/or the prong-end 20a into the socket 15 to install the bulb. Once the bulb is installed, the user may release the grip on the pouch and remove the pouch from the bulb portion, again without any human contact with the glass surface of the bulb portion. The light bulb is thus cleaned and installed with no human contact to the glass surface of the bulb portion and with no contact of any potentially contaminated cloth to the glass surface of the bulb portion, such that the bulb is ready for use with a substantially clean and pure glass surface of the bulb portion 20b.

The present invention thus provides a method of installing and cleaning a lighting bulb of the type that should not come in direct contact with a user's or installer's hand or fingers or skin. For example, the method may include providing a bulb installation/cleaning packet or pouch and opening the pouch (such as via tearing or cutting or peeling or otherwise removing a portion of the pouch to expose the inner liner). The user may then press the perimeter sealed sides toward one another to expand the pouch to further open the receiving end of the pouch so as to adapt the pouch for receiving a bulb therein. The bulb may be held gently in the pouch by the user while the bulb is installed at the socket (such as at a headlamp socket of a vehicle or the like). After the bulb is installed (and optionally before installation such as when the user is holding the prong end of the bulb), the user may gently rotate the pouch relative to the bulb to clean and polish the bulb. The user may then remove the pouch from the installed and cleaned bulb (and may then reassemble or reinstall the headlamp housing or other structure at which the bulb is installed).

Thus, a high heat lighting bulb with a bulb portion and a power connecting portion may be grasped and cleaned and/or installed without human contact with the bulb portion (such as a glass bulb portion or glass-like bulb portion). The lighting bulb, such as a halogen light bulb and such as a halogen light bulb for a headlamp of an automobile, thus may be installed or plugged into a power source or connection receptacle, such as via inserting one or more prongs extending from a base of the bulb into one or more corresponding slots or receptacles of the power source to electrically connect the lighting bulb with the power source. The bulb may be installed while a user or installer grasps only the pouch (and thereby squeezing or holding the bulb portion within the pouch via contact between the inner lining and the outer bulb surface), with the prong or prongs extending outwardly from the pouch for insertion into the power receptacle.

The present invention thus avoids the problems of conventional installation means with a method for inserting or receiving the bulb glass portion into a freshly opened pouch of flexible non-porous material (and with a cloth-like inner element that may contain a cleaning solvent such as alcohol or the like). The closed pouch is opened at the top (or other side or bottom region) and the bulb portion is inserted into the pouch by holding the base, prong-like portion of the bulb (so that the person's skin does not contact the glass bulb portion) during insertion of the bulb portion into the pouch, and with the base portion preferably remaining outside the pouch during the cleaning and/or installation process. The cleaning of the bulb can be effected by massaging and rotating the bulb within the pouch by rotating the base outside the pouch, so as to remove any surface contamination of the bulb glass portion with the solvent and virgin cleaning element. Then, without removing the glass or glass-like portion of the bulb from the pouch, the installer may insert the base prongs of the bulb into the socket—and then remove or slip-off the pouch (which has been cleaning and protecting the bulb portion during the installation process) from the glass bulb portion.

Changes and modifications to the specifically described embodiments may be carried out without departing from the principles of the present invention, which is intended to be limited only by the scope of the appended claims as interpreted according to the principles of patent law including the doctrine of equivalents.

1. A method of handling a high heat lighting bulb, said method comprising:
providing a pouch, said pouch comprising a non-porous flexible outer skin portion and an inner lining comprising a soft cleaning material, said non-porous flexible outer skin portion being substantially sealed around said inner lining;
providing a high heat lighting bulb having a bulb portion and a power connecting portion;
opening said pouch to expose said inner lining, wherein said inner lining forms a receptacle that is configured for receiving said bulb portion of said high heat lighting bulb therein when said pouch is opened; and
inserting said bulb portion of said lighting bulb into said opened pouch and into contact with said inner lining.

2. The method of claim 1, wherein inserting said bulb portion into said pouch comprises inserting said bulb portion of said lighting bulb into said pouch while said power connecting portion of said lighting bulb remains at least partially outside of said receptacle.

3. The method of claim 1, wherein inserting said bulb portion comprises grasping said power connecting portion of said lighting bulb and inserting said bulb portion of said lighting bulb into said pouch.

4. The method of claim 3 further comprising rotating said power connecting portion relative to said pouch to wipe said bulb portion with said inner lining when said bulb portion is received in said receptacle.

5. The method of claim 4, further comprising installing said lighting bulb via connecting said power connecting portion to a power source while holding said lighting bulb via said pouch and without direct human contact with said bulb portion.

6. The method of claim 1, further comprising installing said lighting bulb via connecting said power connecting portion to a power source while holding said lighting bulb via said pouch and without direct human contact with said bulb portion.

7. The method of claim 6, wherein said power connecting portion of said lighting bulb comprises male prongs which are insertable into a female socket to connect said lighting bulb to said power source.

8. The method of claim 1, wherein said inner lining is impregnated with a cleaning solvent.

9. The method of claim 1, wherein said lighting bulb comprises a halogen bulb.

10. The method of claim 9, wherein said halogen bulb comprises a vehicle headlight bulb.

11. The method of claim 1, wherein said non-porous flexible outer skin portion is sealed entirely around said inner lining before said pouch is opened to expose said inner lining.

12. The method of claim 1, wherein opening said pouch comprises tearing said skin portion to expose said inner lining.

13. The method of claim 1, wherein opening said pouch comprises cutting said skin portion to expose said inner lining.

14. A method of handling a high heat lighting bulb, said method comprising:
providing a pouch, said pouch comprising a non-porous flexible outer skin portion and an inner lining comprising a soft cleaning material, said non-porous flexible outer skin portion being substantially sealed around said inner lining;
providing a high heat lighting bulb having a bulb portion and a power connecting portion;
opening said pouch to expose said inner lining, wherein said non-porous flexible outer skin portion is initially sealed entirely around said inner lining before said pouch is opened to expose said inner lining, and wherein said pouch and said inner lining form a receptacle that is configured for receiving said bulb portion of said high heat lighting bulb therein when said pouch is opened; and
grasping said power connecting portion of said lighting bulb and inserting said bulb portion of said lighting bulb into said opened pouch so that said pouch receives said bulb portion of said lighting bulb within said pouch and so that said bulb portion of said lighting bulb contacts said inner lining, while said power connecting portion of said lighting bulb remains at least partially outside of said receptacle.

15. The method of claim 14, further comprising rotating said power connecting portion relative to said pouch when said bulb portion of said lighting bulb is in said pouch to wipe said bulb portion with said inner lining.

16. The method of claim 14, further comprising installing said lighting bulb via connecting said power connecting portion to a power source while holding said lighting bulb via said pouch and without direct human contact with said bulb portion.

17. The method of claim 16, wherein said power connecting portion of said lighting bulb comprises male prongs and wherein installing said lighting bulb comprises inserting said male prongs into a female socket to electrically connect said lighting bulb to said power source.

18. The method of claim 14, wherein providing a pouch comprises providing a pouch with a cleaning solvent at or in said inner lining.

19. The method of claim 14, wherein said lighting bulb comprises a halogen bulb.

20. The method of claim 19, wherein said halogen bulb comprises a vehicle headlight bulb.

21. The method of claim 14, wherein opening said pouch comprises tearing or cutting said skin portion to expose said inner lining.
